(19) United States
(12) Patent Application Publication
(10) Pub. No.: US 2026/0176407 A1
(43) Pub. Date: Jun. 25, 2026

(54) TWO-COMPONENT THERMALLY CONDUCTIVE COMPOSITION OF SILYLATED POLYMAR

(71) Applicant: Bostik SA, COLOMBES (FR)

(72) Inventors: Federico SANZ, VENETTE (FR); Nicolas OLEJNIK, VENETTE (FR)

(21) Appl. No.: 18/870,756

(22) PCT Filed: May 30, 2023
(86) PCT No.: PCT/FR2023/050753

§ 371 Date: Dec. 2, 2024

(30) Foreign Application Priority Data
Jun. 3, 2022 (FR) FR2205382

(51) Int. Cl. C08G 18/40; C08G 77/20; C08K 3/22

(52) U.S. Cl. CPC C08G 18/4018; C08G 77/20; C08K 3/22

(57) ABSTRACT

A thermally-conductive two-component composition comprises a composition (A) comprising a silylated polymer, and a composition (B) comprising at least 1% by weight of a filler (C) relative to the total weight of the composition (B), where the filler (C) provides at least 0.0025% by weight of moisture relative to the total weight of composition (B). Composition (A) and/or composition (B) also comprise at least one thermally-conductive filler, a rheological agent (r1) chosen from amide waxes and/or a rheological agent (r2). The rheological agent (r2) is in the form of a suspension of solid particles of a bis-urea (a) in a continuous phase of a plasticizer (b). The filler (C) has a specific moisture content and facilitates crosslinking, without addition of free water, of a two-component composition, which comprises a composition (A) comprising a silylated polymer, and a composition (B) comprising said filler (C).

### FIELD OF THE INVENTION

The present invention relates to a thermally-conductive two-component silylated polymer composition, and also to its use in particular for improving the service life of a battery. The present invention also relates to the use of a filler (C) having a specific moisture content, for the crosslinking without addition of free water of a two-component silylated polymer composition.

### TECHNICAL BACKGROUND

There are various polymer-based compositions on the market, which can be used in many fields, notably as adhesives and/or mastics. Adhesives and mastics are used for assembling (or else joining or attaching) two substrates which can be chosen from the most diverse materials.

For example, polymer-based compositions can be used as adhesives and/or mastics in building construction, shipbuilding, or the transport sector (for example road, maritime, rail or aerospace transport).

Compositions based on alkoxysilane-terminated polymer (also referred to as silylated polymer) have the advantage of being free of isocyanates. These compositions thus constitute an alternative, which is preferred from a toxicological viewpoint, to the compositions based on isocyanate-terminated polyurethane that are often found on the adhesives market.

The crosslinking reaction of these compositions based on silylated polymer takes place, in the presence of moisture, by hydrolysis of the alkoxysilane groups borne by the polymer, followed by their condensation to form a siloxane bond (—Si—O—Si—) which unites the polymer chains in a solid three-dimensional network.

Certain applications, notably battery manufacturing assemblies, require the polymer-based composition to have specific properties, in particular in terms of thermal conductivity. Specifically, since the recharging of a battery is generally accompanied by an increase in temperature, it is important to limit as much as possible said increase, which is liable to degrade certain electronic circuits or to reduce the service life of the battery. It is therefore important for the silylated polymer composition to have sufficient thermal conductivity to mitigate these problems.

However, closed assemblies such as batteries do not allow sufficient air (and thus moisture) to pass through for the crosslinking reaction of the silylated polymer to take place.

It is possible to use as adhesive a two-component composition comprising on the one hand the silylated polymer to be crosslinked, and on the other hand water. The two components of the adhesive are often packaged separately in the two compartments of a dual cartridge. The dispensing of the adhesive then takes place, at the time of application to the substrates to be assembled, by extrusion of the two components, for example using a dual-cartridge gun, and once their homogeneous mixture obtained, for example by attaching a static mixer to the dual cartridge. The reaction of the component comprising the silylated polymer with the component comprising water allows crosslinking of the silylated polymer.

However, water is hydrophilic, whereas the silylated polymer is hydrophobic. Thus, a processability problem arises during mixing of the components as it is difficult to mix the component comprising water with the component comprising the silylated polymer, the water generally settling on the mixer blades.

There is thus a need to provide a two-component silylated polymer composition that has both good thermal conductivity and good processability.

Furthermore, there is a need to provide a thermally-conductive two-component silylated polymer composition that crosslinks rapidly. This property may be evaluated by measuring the open time of the composition: the shorter it is, the faster the composition crosslinks.

In addition, there is a need to provide a thermally-conductive two-component silylated polymer composition that can be readily applied with a manual dual cartridge while at the same time limiting the risk of sagging, notably in a non-horizontal position.

### SUMMARY OF THE INVENTION

The present invention relates to a thermally-conductive two-component composition comprising:
a composition (A) comprising:
   a silylated polymer, and
   a rheological agent (r1) chosen from amide waxes and/or
   a rheological agent (r2) comprising:
      from 1% to 40% by mass of a bis-urea (a) obtained by reacting a primary aliphatic amine with a diisocyanate having a molar mass of less than 500 g/mol, relative to the total weight of the rheological agent (r2), and
      from 60% to 99% by weight of a plasticizer (b) chosen from alkyl phthalates, pentaerythritol tetravalerate, alkylsulfonic acid esters of phenol, diisononyl 1,2-cyclohexanedicarboxylate, 3,3′-[methylenebis(oxymethylene)]bis[heptane], dioctyl carbonate and mixtures thereof, relative to the total weight of the rheological agent (r2),
      said rheological agent (r2) being in the form of a suspension of solid particles of bis-urea (a) in a continuous phase of plasticizer (b), and
a composition (B) comprising:
   at least 1% by weight of a filler (C) relative to the total weight of the composition (B), the filler (C) providing at least 0.0025% by weight of moisture relative to the total weight of composition (B), composition (A) and/or composition (B) also comprising at least one thermally-conductive filler.

A subject of the present invention is also the use of the thermally-conductive two-component composition according to the invention as an adhesive and/or mastic.

Furthermore, the present invention is also directed toward the use of the thermally-conductive two-component composition according to the invention as an adhesive in the field of building construction, in the field of manufacturing means of transport, preferably the motor vehicle, rail and aerospace industries, and in the field of shipbuilding.

The present invention also relates to the use of the thermally-conductive two-component composition according to the invention for improving the service life of a battery, preferably a rechargeable battery.

Moreover, the invention relates to the use of a filler (C) having a moisture content of between 0.05% and 5% by weight, relative to the total weight of the filler (C), for the crosslinking without addition of free water of a two-component composition, the two-component composition comprising a composition (A) comprising a silylated polymer, and a composition (B) comprising said filler (C).

The present invention is also directed toward an article, notably a battery, comprising the thermally-conductive two-component composition according to the invention.

Finally, the present invention is directed toward to a process for assembling two substrates by adhesive bonding, involving:
coating, onto at least one of the two substrates to be assembled, of the thermally-conductive two-component composition according to the invention, and then
bringing the two substrates into actual contact.

Surprisingly, it has been found that incorporating a filler (C) into composition (B), providing at least 0.0025% by weight of moisture relative to the total weight of composition (B), not only allows improved mixing of composition (A) with composition (B), and thus limits processability problems (notably limiting water deposition on mixer blades), but also leads to rapid crosslinking of the silylated polymer after placing in contact with composition (A), without the need to add (free) water to composition (B).

In addition, the thermally-conductive two-component composition according to the invention may not only be readily applied with a manual dual cartridge (without the need for a pneumatic gun), but also limits the risk of sagging, notably in a non-horizontal position.

### DESCRIPTION OF THE INVENTION

Thus, the invention relates to a thermally-conductive two-component composition comprising:
a composition (A) comprising:
   a silylated polymer, and
a composition (B) comprising:
   at least 1% by weight of a filler (C) relative to the total weight of the composition (B), the filler (C) providing at least 0.0025% by weight of moisture relative to the total weight of composition (B), composition (A) and/or composition (B) also comprising at least one thermally-conductive filler, and composition (A) and/or composition (B), preferably composition (A), also comprising:
   a rheological agent (r1) chosen from amide waxes and/or
   a rheological agent (r2) comprising:
      from 1% to 40% by weight of a bis-urea (a) obtained by reaction of a primary aliphatic amine with a diisocyanate with a molar mass of less than 500 g/mol, relative to the total weight of the rheological agent (r2), and
      from 60% to 99% by weight of a plasticizer (b) chosen from alkyl phthalates, pentaerythritol tetravalerate, alkylsulfonic acid esters of phenol, diisononyl 1,2-cyclohexanedicarboxylate, 3,3′-[methylenebis(oxymethylene)]bis[heptane], dioctyl carbonate and mixtures thereof, relative to the total weight of the rheological agent (r2),
      said rheological agent (r2) being in the form of a suspension of solid particles of the bis-urea (a) in a continuous phase of the plasticizer (b).

### Silvlated Polymer

The term “silylated polymer” means a polymer including at least one alkoxysilane group. Preferably, the silylated polymer comprises at least one alkoxysilane group positioned at the end of the polymer.

The silylated polymer is generally in the form of a more or less viscous liquid. Advantageously, the silylated polymer has a viscosity at 23° C. ranging from 0.5 to 200 Pa·s, preferably from 5 to 120 Pa·s, more preferentially from 15 to 80 Pa·s, even more preferentially from 30 to 60 Pa·s.

The viscosity of the silylated polymer can be measured, for example, according to a Brookfield method at 23° C. and 50% relative humidity (needle S28).

In the context of the invention, the ranges of values are understood to mean limits included. For example, the range “between 0% and 25%” notably includes the values 0% and 25%.

Advantageously, the silylated polymer comprises at least one, preferably at least two, alkoxysilane groups of formula (I):

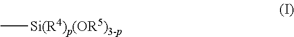

in which:
R⁴ represents a linear or branched alkyl radical comprising from 1 to 4 carbon atoms and, when p is equal to 2, the radicals R⁴ are identical or different,
R⁵ represents a linear or branched alkyl radical comprising from 1 to 4 carbon atoms, and, when p is equal to 0 or 1, the radicals R⁵ are identical or different, two groups OR⁵ possibly being engaged in the same ring, and
p is an integer equal to 0, 1 or 2, preferably equal to 0 or 1.

Preferably, the alkoxysilane groups of the silylated polymer are of formula (I) in which:
R⁴ and R⁵ each represent a methyl radical, and
p is equal to 0 or 1.

Advantageously, the silylated polymer has a number-average molecular mass of between 500 g/mol and 70000 g/mol, preferentially between 1000 g/mol and 60000 g/mol, more preferentially between 2000 g/mol and 50000 g/mol.

The molar mass of the polymers may be measured by methods that are well known to those skilled in the art, for example by NMR or by size exclusion chromatography using polystyrene standards.

Advantageously, the silylated polymer is of formula (II), (III) or (IV):

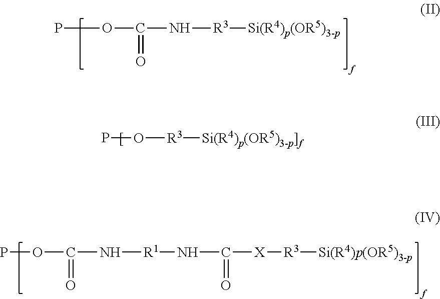

in which:
R⁴, R⁵ and p have the same meaning as in formula (I) described above,
P represents a saturated or unsaturated polymer radical, bearing a linear or branched open chain, or comprising one or more optionally aromatic rings, optionally comprising one or more heteroatoms, such as oxygen, nitrogen, sulfur and/or silicon, preferably oxygen and/or nitrogen,
R¹ represents a saturated or unsaturated divalent hydrocarbon-based radical comprising from 5 to 15 carbon atoms, with a linear or branched open chain, or comprising one or more optionally aromatic rings,
R³ represents a linear or branched divalent alkylene radical comprising from 1 to 6 carbon atoms, preferably from 1 to 3 carbon atoms,
X represents a divalent radical chosen from —NH—, —NR⁷— or —S—,
R⁷ represents a linear or branched alkyl radical comprising from 1 to 20 carbon atoms and which may also comprise one or more heteroatoms,
f is an integer ranging from 1 to 6, advantageously from 2 to 5, preferentially from 2 to 4, even more preferentially from 2 to 3.

Advantageously, the silylated polymer is of formula (II), (III) or (IV) with P representing a polymer radical chosen from polyethers, polycarbonates, polyesters, polyolefins, polyacrylates, polyether polyurethanes, polyester polyurethanes, polyolefin polyurethanes, polyacrylate polyurethanes, polycarbonate polyurethanes, block polyether/polyester polyurethanes, preferably chosen from polyethers, polyurethanes and mixtures thereof, more preferentially from polyethers.

Preferably, the silylated polymer is of formula (II′), (II″), (III′) or (IV′):

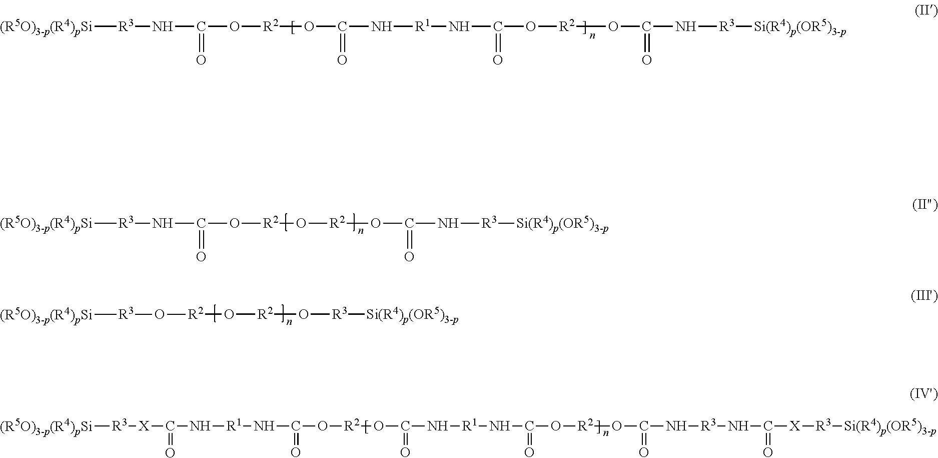

in which:
R¹, R³, R⁴, R⁵, X, R⁷ and p have the same meaning as in formulae (II), (III) and (IV),
R² represents a saturated or unsaturated, linear or branched divalent hydrocarbon-based radical optionally comprising one or more heteroatoms, such as oxygen, nitrogen, sulfur, silicon,
n is an integer, preferably n is such that the number-average molecular mass of the silylated polymer is between 500 g/mol and 70000 g/mol, more preferentially between 1000 g/mol and 60000 g/mol, even more preferentially between 2000 g/mol and 50000 g/mol.

In the silylated polymers of formula (II′), (II″), (III′) or (IV′) defined above, when the radical R² comprises one or more heteroatoms, said heteroatom(s) are not present at the end of the chain. In other words, the free valencies of the divalent radical R² bonded to the oxygen atoms neighboring the silylated polymer each originate from a carbon atom. Thus, the main chain of the radical R² is terminated with a carbon atom at each of the two ends, said carbon atom then having a free valency.

According to one embodiment, the silylated polymers are obtained from polyols chosen from polyether polyols, polyester polyols, polycarbonate polyols, polyacrylate polyols, polysiloxane polyols, polyolefin polyols, and mixtures thereof, preferably from diols chosen from polyether diols, polyester diols, polycarbonate diols, polyacrylate diols, polysiloxane diols, polyolefin diols, and mixtures thereof, more preferentially from polyether diols. In the case of the polymers of formula (II′), (II″), (III′) or (IV′) described above, such diols may be represented by the formula HO—R²—OH or H—[O—R²]ₙ—OH where R² has the same meaning as in formula (II′), (II″), (III′) or (IV′).

According to one embodiment, when the silylated polymer is of formula (II′) or (IV′), the radical R² may be chosen from the following divalent radicals, the formulae of which below show the two free valencies:
derivative of a polypropylene glycol:

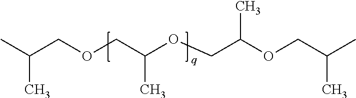

derivative of a polyester diol:

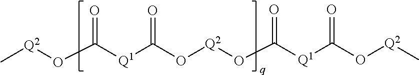

derivative of a polybutadiene diol:

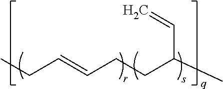

derivative of a polyacrylate diol:

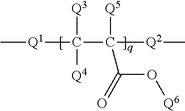

derivative of a polysiloxane diol:

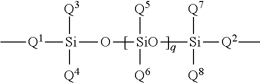

in which:
q represents an integer such that the number-average molar mass of the radical R² ranges from 100 g/mol to 48600 g/mol, preferably from 300 g/mol to 18600 g/mol, more preferably from 500 g/mol to 12600 g/mol,
r and s represent zero or a non-zero integer such that the number-average molar mass of the radical R² ranges from 100 g/mol to 48600 g/mol, preferably from 300 g/mol to 18600 g/mol, more preferably from 500 g/mol to 12600 g/mol, it being understood that the sum r+s is other than zero,
Q¹ represents a linear or branched, saturated or unsaturated aromatic or aliphatic divalent alkylene radical preferably containing from 1 to 18 carbon atoms, more preferably from 1 to 8 carbon atoms,
Q² represents a linear or branched divalent alkylene radical preferably containing from 2 to 36 carbon atoms, more preferably from 1 to 8 carbon atoms,
Q³, Q⁴, Q⁵, Q⁶, Q⁷ and Q⁸ represent, independently of each other, a hydrogen atom or an alkyl, alkenyl or aromatic radical preferably containing from 1 to 12 carbon atoms, preferably from 2 to 12 carbon atoms, more preferably from 2 to 8 carbon atoms.

According to one embodiment, R¹ is chosen from the following divalent radicals, of which the formulae below reveal the two free valencies:
a) the divalent radical derived from isophorone diisocyanate (IPDI):

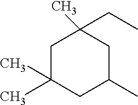

b) the divalent radical derived from dicyclohexylmethane diisocyanate (H12MDI):

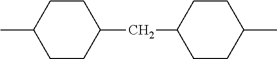

c) the divalent radicals derived from the 2,4-and 2,6-isomers of toluene diisocyanate (TDI):

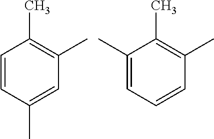

d) the divalent radicals derived from the 4,4′- and 2,4′-isomers of diphenylmethane diisocyanate (MDI):

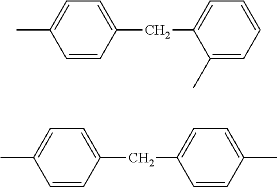

e) the divalent radical derived from hexamethylene diisocyanate (HDI): —(CH₂)₆—
f) the divalent radical derived from m-xylylene diisocyanate (m-XDI):

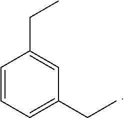

According to a preferred embodiment, the silylated polymer is of formula (II″) (preferably with R³ representing a divalent linear or branched alkylene radical comprising 3 carbon atoms) or (III′), preferentially (III′), and the radical R² preferably represents a linear or branched divalent alkylene radical comprising from 2 to 4 carbon atoms, more preferentially a linear or branched divalent alkylene radical comprising 3 carbon atoms, even more preferentially an isopropylene radical (of formula —CH₂—CH(CH₃)—).

According to a particularly preferred embodiment, the silylated polymer is a polymer of formula (III′) in which:
R² represents an isopropylene radical,
R⁵ represents a methyl radical, and
p is equal to 0.

The polymers of formula (II), (II′) or (II″) may be obtained according to a process described, for example, in EP 2336208 and WO 2009/106699. Among the polymers corresponding to formula (II), mention may be made of:
Geniosil® STP-E10 (available from Wacker-Chemie): polyether of formula (II″) comprising two groups of formula (I) of dimethoxy type (p equal to 1 and R⁴ and R⁵ represent a methyl group) having a number-average molar mass of 8889 g/mol where R³ represents a methyl group;
Geniosil® STP-E30 (available from Wacker-Chemie): polyether of formula (II″) comprising two groups of formula (I) of dimethoxy type (p equal to 1 and R⁴ and R⁵ represent a methyl group) having a number-average molar mass of 14493 g/mol where R³ represents a methyl group;
Desmoseal® S XP 2636 (available from Bayer): polyurethane comprising two groups of formula (I) of trimethoxy type (p equal to 0 and R⁵ represents a methyl group) having a number-average molar mass of 15038 g/mol where R³ represents an n-propylene group.

The polymers of formula (III) or (III′) may be obtained by hydrosilylation of polyether diallyl ether according to a process described, for example, in EP 1 829 928. Among the polymers corresponding to formula (III), mention may be made of:
the polymer MS SAX® 350 (available from Kaneka) corresponding to a polyether comprising two groups of formula (I) of dimethoxy type (p equal to 1 and R⁴ and R⁵ represent a methyl group) having a number-average molar mass ranging from 14000 to 16000 g/mol;
the polymer MS SAX® 260 (available from Kaneka) corresponding to a polyether comprising two groups of formula (I) of dimethoxy type (p equal to 1 and R⁴ and R⁵ represent a methyl group) having a number-average molar mass of 16000 to 18000 g/mol where R³ represents an ethyl group;
the polymer MS S303H (available from Kaneka) corresponding to a polyether comprising two groups of formula (I) of dimethoxy type (p is equal to 1 and R⁴ represents a methyl group) having a number-average molar mass of from 21000 to 23000 g/mol;
the polymer MS SAX® 520 (available from Kaneka) corresponding to a polyether comprising two groups of formula (I) of trimethoxy type (p equal to 0 and R⁵ represents a methyl group) having a number-average molar mass ranging from 29000 to 31000 g/mol.

The polymers of formula (IV) or (IV′) may be obtained, for example, by reaction of polyol(s) with one or more diisocyanates followed by a reaction with aminosilanes or mercaptosilanes. A process for preparing polymers of formula (IV) or (IV′) is described, for example, in EP 2 583 988. A person skilled in the art will know how to adapt the manufacturing process described in said document in the case of using different types of polyols. Among the polymers corresponding to formula (IV), mention may be made of:
Spur+@1050MM (available from Momentive): polyurethane comprising two groups of formula (I) of trimethoxy type (p equal to 0 and R⁵ represents a methyl group) having a number-average molar mass of 16393 g/mol where R³ represents an n-propyl group;
Spur+® Y-19116 (available from Momentive): polyurethane comprising two groups of formula (I) of trimethoxy type (p equal to 0 and R⁵ represents a methyl group) having a number-average molar mass ranging from 15000 to 17000 g/mol g/mol where R³ represents an n-propyl group.

The content of silylated polymer in composition (A) may range from 3% to 40% by weight relative to the total weight of composition (A), preferentially from 5% to 35% by weight, more preferentially from 10% to 30% by weight, even more preferentially from 14% to 28% by weight, in particular from 17% to 22% by weight.

### Rheological Agent

The total content of rheological agent in composition (A) may range from 0.2% to 15% by weight, preferably from 1% to 10% by weight and more preferentially from 1% to 5% by weight relative to the total weight of composition (A).

The total content of rheological agent in composition (B) may range from 0.2% to 15% by weight, preferably from 1% to 10% by weight and more preferentially from 1% to 5% by weight relative to the total weight of composition (B).

Preferably, composition (A) and/or composition (B) comprise a rheological agent (r2). In particular, the rheological agent (r2) is the sole rheological agent in composition (A) and/or composition (B).

Preferably, composition (A) comprises a rheological agent (r2). In particular, the rheological agent (r2) is the sole rheological agent in composition (A).

Advantageously, only composition (A) comprises a rheological agent, preferably a rheological agent (r2). In particular, the rheological agent (r2) is the sole rheological agent in composition (A).

Rheoloqical agent (r1) The term “amide waxes” is understood to mean waxes comprising one or more compounds containing at least one amide group. In particular, amide waxes can be obtained from fatty acid(s) (for example ricinoleic acid) and (di)amine(s).

The amide waxes are preferably micronized, that is to say that they have a mean particle size of less than 1 mm. Advantageously, the amide waxes have a mean particle size of less than 500 μm, preferably less than 100 μm, more preferentially less than 10 μm.

The mean particle size advantageously corresponds to the d50 particle size, i.e. the maximum size of 50% of the smallest particles by volume, and can be measured with a particle size analyzer, notably by laser diffraction on a Malvern machine (for example according to the standard NF ISO 13320).

Unless otherwise indicated, the standards mentioned throughout the patent application are those in force on the date of filing of the patent application.

Rheological agents of amide wax type are generally heat activatable, that is to say that a temperature above room temperature (23° C.) may be needed in order to activate it (in particular, to activate its rheological properties) during the preparation of the composition according to the invention.

The activation temperature depends on the rheological agent.

Preferably, the activation temperature of the rheological agent (r1) is less than or equal to 80° C., more preferentially less than 65° C., and even more preferentially less than 55° C.

Examples of commercial amide waxes include Crayvallac® SLX or Crayvallac® SLT sold by Arkema, or else Thixatrol® AS8053 or Thixatrol® MAX (EC No.: 432-430-3) which are available from Elementis.

### Rheological Aqent (r2)

Advantageously, the rheological agent (r2) is such that the bis-urea (a) is obtained by reacting an n-alkylamine (a1) comprising from 1 to 22 carbon atoms, preferably n-butylamine, with a diisocyanate (a2) of formula (V):

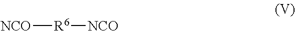

in which R⁶ is chosen from one of the following divalent radicals, of which the formulae below reveal the two free valencies:
i) the divalent radical derived from isophorone:

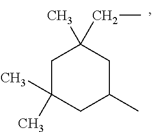

ii) the divalent radical 4,4′-methylenebis(cyclohexyl):

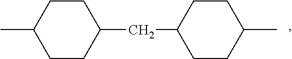

iii) the divalent radical derived from toluene 2,4-diisocyanate (or 2,4-TDI) or from toluene 2,6-diisocyanate (or 2,6-TDI) of respective formulae:

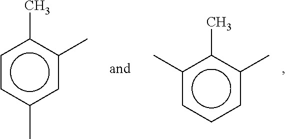

iv) the divalent radical derived from diphenylmethylene 4,2′-diisocyanate (or 4,2′-MDI) or from diphenylmethylene 4,4′-diisocyanate (or 4,4′-MDI), of respective formulae:

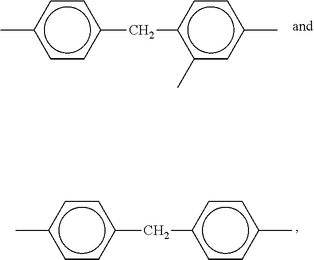

v) the hexamethylene radical: —(CH₂)₆—,
vi) the m-xylylene radical:

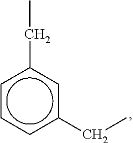

and
vii) the hexahydro-m-xylylene radical:

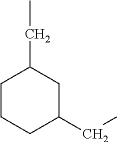

Preferably, the diisocyanate (a2) is of formula (V) in which R⁶ is the divalent radical derived from 4,2′-MDI or 4,4′-MDI, preferably 4,4′-MDI.

According to a preferred embodiment, the bis-urea (a) is obtained by reacting n-butylamine with a diisocyanate (a2) of formula (V) in which R⁶ is the divalent radical derived from 4,2′-MDI or 4,4′-MDI, preferably 4,4′-MDI.

As indicated above, the plasticizer (b) is chosen from alkyl phthalates, pentaerythritol tetravalerate, alkylsulfonic acid esters of phenol, diisononyl 1,2-cyclohexanedicarboxylate, 3,3′-[methylenebis(oxymethylene)]bis[heptane], dioctyl carbonate and mixtures thereof.

The alkyl phthalates are preferably formed from the group consisting of diisodecyl phthalate (DIDP), bis(2-propylheptyl) phthalate and mixtures thereof.

As regards pentaerythritol tetravalerate, mention may be made of the product sold under the brand name Pevalen® by the company Perstorp.

As regards an ester of alkylsulfonic acid and of phenol, mention may be made of the product Mesamoll® sold by the company Lanxess.

As regards diisononyl 1,2-cyclohexanedicarboxylate, mention may be made of the product sold under the name Hexamoll Dinch® by the company BASF. 3,3′-[Methylenebis(oxymethylene)]bis[heptane] can be identified by its CAS number: 22174-70-5, and is also known under the trade name of 2-ethylhexylal, available from Lambiotte.

Finally, dioctyl carbonate (EC No.: 434-850-2) is available from BASF.

Advantageously, the rheological agent (r2) is such that the plasticizer (b) is chosen from alkyl phthalates; preferably, the plasticizer (b) is chosen from diisodecyl phthalate, bis(2-propylheptyl) phthalate and mixtures thereof; more preferentially, the plasticizer (b) is diisodecyl phthalate.

According to a preferred embodiment, the rheological agent (r2) consists of:
from 1% to 40% by weight of a bis-urea (a) obtained by reaction of a primary aliphatic amine with a diisocyanate with a molar mass of less than 500 g/mol, relative to the total weight of the rheological agent (r2), and
from 60% to 99% by weight of a plasticizer (b) chosen from alkyl phthalates, pentaerythritol tetravalerate, alkylsulfonic acid esters of phenol, diisononyl 1,2-cyclohexanedicarboxylate, 3,3′-[methylenebis(oxymethylene)]bis[heptane], dioctyl carbonate and mixtures thereof, relative to the total weight of the rheological agent (r2),
said rheological agent (r2) being in the form of a suspension of solid particles of the bis-urea (a) in a continuous phase of plasticizer (b), and the bis-urea (a) and the plasticizer (b) being as described above, including the embodiments.

Advantageously, the rheological agent (r2) comprises, and preferably consists of, from 5% to 30% by weight of bis-urea (a) and from 70% to 95% by weight of plasticizer (b), the percentages being relative to the total weight of said rheological agent (r2).

The bis-urea (a) and the plasticizer (b) are as described above, including the embodiments.

The rheological agent (r2) used in the thermally-conductive two-component composition according to the invention may be prepared according to the process described hereinbelow.

The reaction of the primary aliphatic amine with the diisocyanate is highly exothermic. To prevent the large amount of heat formed by the reaction from leading to the decomposition of the bis-urea formed, the primary aliphatic amine and the diisocyanate are each dissolved in the plasticizer (b), prior to them reacting together, said plasticizer (b) thus serving to evacuate the heat formed by the reaction. The two solutions in the plasticizer (b) of the primary aliphatic amine and the diisocyanate are advantageously each introduced into a reactor via injectors, under a pressure of 40 to 200 bar, preferably of 80 to 120 bar, the two solutions thus being brought into contact in the sprayed liquid state. The amounts of reagents preferably correspond to a (number of moles of primary aliphatic amine)/(number of moles of diisocyanate) ratio of about 2. The bis-urea is produced by the reaction in the form of solid particles dispersed in a continuous phase of plasticizer b), the Brookfield viscosity of the corresponding suspension, measured at a temperature of 23° C., being generally between 1 and 50 Pa·s, preferably between 10 and 25 Pa·s.

The term “about X” is intended to mean plus or minus 10% of the value of X.

### Filler (C)

The filler (C) of composition (B) comprises a residual moisture that allows the alkoxysilyl groups of the silylated polymer to be hydrolyzed, which advantageously leads to crosslinking of the silylated polymer, without the need to add water to composition (B).

The filler (C) is different from the thermally-conductive filler.

Incorporating this filler (C) into composition (B) advantageously affords a more homogeneous thermally-conductive two-component composition. Specifically, as composition (A) is hydrophobic, notably due to the presence of the silylated polymer, mixing with composition (B) is thus facilitated when water is provided by filler (C).

Advantageously, filler (C) provides at least 0.005% by weight of moisture relative to the total weight of composition (B), preferably at least 0.010% by weight, more preferentially at least 0.015% by weight.

Advantageously, the filler (C) provides between 0.0025% and 1% by weight of moisture relative to the total weight of composition (B), preferably between 0.005% and 0.8% by weight, more preferentially between 0.010% and 0.5% by weight, even more preferentially between 0.015% and 0.2% by weight.

The moisture provided by the filler (C) may be determined by taking into account the filler (C) content of composition (B), and also the moisture content of said filler (C). For example, if composition (B) comprises 5% by weight of a filler (C), relative to the total weight of composition (B), and filler (C) comprises 0.5% by weight of moisture relative to the total weight of filler (C), then filler (C) provides (5×0.5)/100=0.025% by weight of moisture relative to the total weight of composition (B).

Advantageously, the moisture content of the filler (C) is between 0.05% and 5% by weight relative to the total weight of the filler (C), preferably between 0.1% and 3% by weight, more preferentially between 0.10% and 2% by weight.

A person skilled in the art knows how to determine the moisture content of a filler (C). The moisture content of the filler (C) may be determined according to the Karl Fisher method by electrometrically determining the equivalence point. For example, the moisture content may be determined using the protocol described in Example 1 hereinbelow.

The mean particle size of the filler (C) may range from 10 nm to 400 μm; preferably from 20 nm to 100 μm, more preferentially from 30 nm to 50 μm.

The mean particle size advantageously corresponds to the d50 particle size, i.e. the maximum size of 50% of the smallest particles by volume, and can be measured with a particle size analyzer, notably by laser diffraction on a Malvern machine (for example according to the standard NF ISO 13320).

Advantageously, the filler (C) is chosen from clays, talc, kaolins, gypsum, carbonate fillers, zeolites, expandable graphite and mixtures thereof.

Preferably, the filler (C) is chosen from carbonate fillers, zeolites, expandable graphite and mixtures thereof, more preferentially from carbonate fillers, zeolites and mixtures thereof.

Advantageously, the carbonate fillers are formed from the group consisting of alkali metal or alkaline-earth metal carbonates and mixtures thereof; preferably, the carbonate fillers are calcium carbonate or chalk, more preferentially calcium carbonate, in particular precipitated calcium carbonate coated with fatty acids.

When calcium carbonate is coated with fatty acids, this makes it possible to impart total or partial hydrophobicity to the calcium carbonate particles. Moreover, the fatty acid coating acts as a hydrophobic coating which can prevent the calcium carbonate from absorbing the constituents of the composition and from rendering them ineffective. The hydrophobic coating of the calcium carbonate can represent from 0.1% to 3.5% by weight, relative to the total weight of calcium carbonate.

Preferably, the fatty acids coating the calcium carbonate comprise or consist of more than 50% by weight of stearic acid relative to the total weight of the fatty acids.

Examples of precipitated calcium carbonate coated with fatty acids that may be mentioned include Hakuenka® CCR-S10 (sold by Omya) or Calofort® SV14 (sold by Specialty Minerals).

Advantageously, the zeolites are chosen from synthetic zeolites of type A, X and/or Y, preferably type A, and have a pore diameter of between 3 Å and 5 Å, preferably 3 Å.

According to a preferred embodiment, the filler (C) is precipitated calcium carbonate coated with fatty acids and/or a type A synthetic zeolite with a pore diameter of 3 Å.

Advantageously, the content of filler (C) ranges from 1% to 25% by weight relative to the total weight of composition (B), preferably from 2% to 20% by weight, more preferentially from 4% to 15% by weight, even more preferentially from 6% to 11% by weight.

### Thermally-Conductive Filler

The thermally-conductive filler allows heat diffusion by virtue of its thermal conductivity value. In particular, the thermally-conductive filler has a thermal conductivity of greater than or equal to 3 W/mK, preferably greater than or equal to 5 W/mK, more preferentially greater than or equal to 10 W/mK.

The thermal conductivity of the conductive filler may be determined via any method known to those skilled in the art. Advantageously, the thermal conductivity is determined according to the standard ASTM D5740.

Advantageously, the thermally-conductive filler is electrically insulating. The term “electrically insulating” means in particular an electrical conductivity of less than or equal to 0.1 S/m at 23° C., preferably less than or equal to 0.01 S/m at 23° C.

The thermally-conductive filler allows good thermal conductivity to be imparted to the thermally-conductive two-component composition according to the invention.

Thus, the thermal conductivity of composition (A) and/or composition (B) is advantageously between 0.5 and 3 W/mK, preferably between 1.0 and 2.0 W/mK, more preferentially equal to about 1.5 W/mK.

The thermal conductivity of compositions (A) and (B) is preferably determined using the ASTM D5470 method.

The moisture content of the thermally-conductive filler is advantageously less than 0.05% by weight relative to the total weight of the thermally-conductive filler, preferably less than 0.03% by weight. The moisture content may be determined according to the Karl Fisher method by electrometrically determining the equivalence point, for example by following the protocol described in Example 1 hereinbelow.

The at least one thermally-conductive filler may be chosen from aluminosilicates, alumina, aluminum hydroxide, aluminum nitride, boron nitride, zinc oxide, magnesium oxide and mixtures thereof, advantageously from aluminosilicates, alumina, aluminum hydroxide, boron nitride, zinc oxide, magnesium oxide and mixtures thereof, preferably from aluminosilicates, alumina, aluminum hydroxide and mixtures thereof, more preferentially from aluminosilicates and mixtures thereof.

The thermally-conductive filler is preferably of natural origin (i.e. not synthetic).

The thermally-conductive filler advantageously does not have a three-dimensional crystalline structure with pores at least 3 Å in diameter.

Preferably, composition (A) and/or composition (B) comprise at least two thermally-conductive fillers.

Advantageously, the total content of thermally-conductive filler(s) in composition (A) ranges from 50% to 90% by weight relative to the total weight of composition (A), preferably from 60% to 87% by weight, more preferentially from 65% to 85% by weight, even more preferentially from 70% to 80% by weight.

Advantageously, the total content of thermally-conductive filler(s) in composition (B) ranges from 50% to 90% by weight relative to the total weight of composition (B), preferably from 60% to 87% by weight, more preferentially from 65% to 85% by weight, even more preferentially from 70% to 80% by weight.

According to a preferred embodiment, each of the compositions (A) and (B) comprises at least one thermally-conductive filler. Preferably, each of the compositions (A) and (B) comprises at least two thermally-conductive fillers.

Advantageously, the thermal conductivity of each of the compositions (A) and (B) is between 0.5 and 3 W/mK, preferably between 1.0 and 2.0 W/mK, more preferentially equal to about 1.5 W/mK.

Advantageously, the total content of thermally-conductive filler(s) in each of the compositions (A) and (B) ranges from 50% to 90% by weight relative to the total weight of each of the compositions (A) and (B), preferably from 60% to 87% by weight, more preferentially from 65% to 85% by weight, even more preferentially from 70% to 80% by weight.

According to one embodiment, composition (A) and/or composition (B), preferably each of the compositions (A) and (B), comprise at least two thermally-conductive fillers, the thermally-conductive fillers in said composition having different particle sizes. Advantageously, the difference in particle size d50 between two of the thermally-conductive fillers is between 3 μm and 25 μm, preferably between 5 μm and 20 μm, more preferentially between 10 μm and 14 μm.

The particle size d50 is well known to those skilled in the art as being the maximum size of 50% of the smallest particles by volume, and can be measured with a particle size analyzer, notably by laser diffraction on a Malvern machine (for example according to the standard NF ISO 13320).

### Adhesion Promoter

Composition (A) and/or composition (B) may also comprise at least one adhesion promoter.

Advantageously, the adhesion promoter is chosen from amino-, mercapto-and epoxy-alkoxysilanes, preferably from aminoalkoxysilanes, more preferentially from aminotrialkoxysilanes, even more preferentially from aminotrimethoxysilanes, for example 3-aminopropyltrimethoxysilane.

As an example of an epoxyalkoxysilane, mention may be made of (3-glycidyloxypropyl)trimethoxysilane (also known as GLYMO).

Advantageously, the aminotrimethoxysilanes are formed by the group consisting of 4-amino-3,3-dimethylbutyltrimethoxysilane (for example Silquest A-Link 600 sold by Momentive), (3-aminopropyl)trimethoxysilane (for example Dynasylan® AMMO sold by Evonik) and N-(2-aminoethyl)-3-aminopropyltrimethoxysilane (for example Dynasylan® DAMO or DAMO-T sold by Evonik). Preferably, the aminotrimethoxysilane is (3-aminopropyl)trimethoxysilane.

The content of adhesion promoter may range from 0.1% to 3% by weight, preferably from 0.2% to 2% by weight and more preferentially from 0.5% to 1.5% by weight relative to the total weight of composition (A).

The content of adhesion promoter may range from 0.1% to 3% by weight, preferably from 0.2% to 2% by weight and more preferentially from 0.5% to 1.5% by weight relative to the total weight of composition (B).

According to one embodiment, the content of adhesion promoter in each of the compositions (A) and (B) ranges from 0.1% to 3% by weight, preferably from 0.2% to 2% by weight and more preferentially from 0.5% to 1.5% by weight relative to the total weight of each of the compositions (A) and (B).

Advantageously, composition (A) and/or (B) comprises at least one adhesion promoter.

Preferably, the adhesion promoter is in composition (A) only.

### Crosslinking Catalyst

Composition (B) may also comprise a crosslinking catalyst.

The crosslinking catalyst may be any catalyst known to those skilled in the art for the condensation of silanol. Examples of such catalysts that may be mentioned include:
organotitanium derivatives such as titanium acetylacetonate (for example Tyzor@AA75 sold by Dorf Ketal),
aluminum, such as aluminum chelate (for example K-KAT@5218 sold by King Industries),
amines such as 1,8-diazabicyclo[5.4.0]undec-7-ene (DBU) or 1,5-diazabicyclo[4.3.0]non-5-ene (DBN), 2,2′-dimorpholinodiethyl ether (DMDEE) and 1,4-diazabicyclo[2.2.2]octane (DABCO),
catalysts based on zinc carboxylate and DBU (for example K-KAT@670 sold by King Industries),
tin-based catalysts such as compounds derived from dioctyltin or dibutyltin; in particular dioctyltin oxide, dioctyltin diacetate, dioctyltin dilaurate, dioctyltin dicarboxylate, dibutyltin diacetylacetonate (DBTDAA), dibutyltin dilaurate (DBTDL), dibutyltin diacetate, dibutyltin oxide or the product of reaction of bis(acetyloxy)dioctyltin with tetraethyl orthosilicate, preferably the product of reaction of bis(acetyloxy)dioctyltin with tetraethyl orthosilicate. Mention may be made, for example, of Neostann@S-1 (sold by Kaneka), or TIB KAT@425 or TIB KAT@423 (sold by TIB Chemicals),

Advantageously, the crosslinking catalyst is a tin-based catalyst, for example derived from the reaction of bis(acetyloxy)dioctyltin with tetraethyl orthosilicate.

Preferably, the crosslinking catalyst is a tin-based catalyst chosen from the compounds derived from dioctyltin and dibutyltin; more preferentially, the tin-based catalyst is derived from the reaction of bis(acetyloxy)dioctyltin with tetraethyl orthosilicate (CAS No.: 93925-43-0).

The content of crosslinking catalyst may range from 0.01% to 1.5% by weight, preferably from 0.02% to 1.0% by weight and more preferentially from 0.1% to 0.5% by weight relative to the total weight of composition (B).

Advantageously, composition (B) comprises a crosslinking catalyst.

### Flame Retardant

Composition (A) and/or composition (B) may also comprise a flame retardant.

Preferably, the flame retardant is chosen from triaryl phosphates, trialkyl phosphates and mixtures thereof, more preferentially from tricresyl phosphate, cresyl diphenyl phosphate, tributyl phosphate, trioctyl phosphate, tris(2-ethylhexyl) phosphate, tris(chloroethyl) phosphate, tris(dichloropropyl) phosphate, tris(dibromopropyl) phosphate and mixtures thereof, even more preferentially cresyl diphenyl phosphate.

The content of flame retardant may range from 1% to 20% by weight, preferably from 5% to 18% by weight and more preferentially from 8% to 15% by weight relative to the total weight of composition (B).

The content of flame retardant may range from 1% to 20% by weight, preferably from 5% to 18% by weight and more preferentially from 8% to 15% by weight relative to the total weight of composition (A).

The content of flame retardant in each of the compositions (A) and (B) may range from 1% to 20% by weight, preferably from 5% to 18% by weight and more preferentially from 8% to 15% by weight relative to the total weight of each of the compositions (A) and (B).

Advantageously, composition (A) and/or composition (B) comprises a flame retardant.

Preferably, the flame retardant is in composition (B) only.

### Other Additives

The thermally-conductive two-component composition according to the invention may also comprise at least one additive. The additive may be in composition (A) and/or (B). Preferably, the additive is chosen from plasticizers, solvents and UV stabilizers, and mixtures thereof.

Advantageously, the thermally-conductive two-component composition according to the invention comprises a mixture of additives chosen from plasticizers, solvents and UV stabilizers (or antioxidants).

Water is not considered to be a solvent for the purposes of the invention.

The total content of additives may range from 0.1% to 10% by weight, preferably from 1% to 5% by weight and more preferentially from 2% to 3% by weight relative to the total weight of the thermally-conductive two-component composition.

Advantageously, the thermally-conductive two-component composition according to the invention comprises an additive chosen from plasticizers.

The term “an additive chosen from plasticizers” means a plasticizer which may be plasticizer (b) in composition (B), and/or a plasticizer which may be plasticizer (b) in composition (A) when composition (A) does not comprise a rheological agent (r2), or a second plasticizer other than plasticizer (b) in composition (A) when composition (A) comprises a rheological agent (r2).

Preferably, the additive chosen from plasticizers is introduced into composition (B).

The additive chosen from plasticizers can be any plasticizer commonly used in the field of adhesive compositions.

Preferably, this plasticizer is chosen from:
diisodecyl phthalate (for example Palatinol® DIDP sold by BASF),
diisononyl phthalate (DINP) (for example Palatinol® N sold by BASF),
an alkylsulfonic acid ester of phenol (for example Mesamoll® sold by Lanxess),
diisononyl hexahydrophthalate (for example Hexamoll Dinch® sold by BASF), and
pentaerythritol tetravalerate (for example Pevalen^{T}M sold by Perstorp).

More preferentially, this plasticizer is diisononyl hexahydrophthalate (CAS No.: 166412-78-8).

According to a preferred embodiment, the content of additive chosen from plasticizers ranges from 1% to 15% by weight, preferably from 2% to 10% by weight and more preferentially from 3% to 7% by weight relative to the total weight of composition (B).

The thermally-conductive two-component composition according to the invention may comprise from 0% to 5% by weight of a solvent relative to the total weight of said composition, preferably a solvent that is volatile at room temperature (temperature of about 23° C.). The volatile solvent may be chosen, for example, from alcohols that are volatile at room temperature, such as ethanol or isopropanol. Preferably, the thermally-conductive two-component composition comprises from 0% to 1% by weight and more preferentially from 0% to 0.5% by weight of a solvent relative to the total weight of said composition.

Advantageously, the thermally-conductive two-component composition according to the invention comprises up to 1% by weight, preferably up to 0.5% by weight, of one or more UV stabilizers (or antioxidants) relative to the total weight of said composition. The UV stabilizers are typically introduced to protect the composition from degradation resulting from a reaction with oxygen which is liable to be formed by the action of heat or light. These compounds may include antioxidants that are capable of scavenging free radicals.

Advantageously, the UV stabilizer(s) (or antioxidants) are chosen from benzotriazoles, benzophenones, “hindered” amines such as bis(1-octyloxy-2,2,6,6-tetramethyl-4-piperidyl) sebacate, bis(2,2,6,6-tetramethyl-4-piperidyl) sebacate, bis(1,2,2,6,6-pentamethyl-4-piperidyl) sebacate (CAS No.: 41556-26-7), methyl 1,2,2,6,6-pentamethyl-4-piperidyl sebacate (CAS No.: 82919-37-7), octadecyl 3-(3,5-di-tert-butyl-4-hydroxyphenyl)propionate, 4,4′-bis(α,α-dimethylbenzyl)diphenylamine, and mixtures thereof. Mention may be made, for example, of the products Irganox 1076, Tinuvin®292, Tinuvin® 765 or Tinuvin® 770 DF sold by BASF, Riasorb UV-123 sold by Rianlon and Okabest CLX 50 sold by OKA.

Preferably, the UV stabilizer(s) (or antioxidants) are chosen from hindered amines such as bis(1-octyloxy-2,2,6,6-tetramethyl-4-piperidyl) sebacate, bis(2,2,6,6-tetramethyl-4-piperidyl) sebacate, octadecyl 3-(3,5-di-tert-butyl-4-hydroxyphenyl)propionate, 4,4′-bis(α,α-dimethylbenzyl)diphenylamine, and mixtures thereof.

More preferentially, the UV stabilizers (or antioxidants) are a mixture of bis(1-octyloxy-2,2,6,6-tetramethyl-4-piperidyl) sebacate, bis(2,2,6,6-tetramethyl-4-piperidyl) sebacate, octadecyl 3-(3,5-di-tert-butyl-4-hydroxyphenyl)propionate and 4,4′-bis(α,α-dimethylbenzyl)diphenylamine.

Advantageously, the thermally-conductive two-component composition according to the invention does not comprise any moisture absorber, notably chosen from vinyltrimethoxysilane, vinyltriethoxysilane, alkoxyarylsilanes and p-toluenesulfonyl isocyanate.

### Other Features of the Thermally-Conductive Two-Component Composition According to the Invention

Advantageously, the volume ratio of composition (A) to composition (B) is between 0.25 and 4, preferably between 0.5 and 2, more preferentially between 0.8 and 1.2, for example equal to 1.0.

Advantageously, composition (B) does not comprise any water.

The term “does not comprise any water” refers to a composition in which the presence of water is solely due to the presence of moisture in the composition's ingredients (no added water).

Advantageously, composition (B) has a moisture content of less than 1% by weight relative to the total weight of composition (B), preferably less than 0.8% by weight, more preferentially less than 0.5% by weight, even more preferentially less than or equal to 0.2% by weight.

The moisture content of composition (B) may be determined by summing the moisture contents provided by each of the ingredients of which it is made. Preferably, only the filler (C) has a significant moisture content, i.e. at least 0.05% by weight relative to the total weight of the filler (C). Thus, the moisture content of composition (B) preferentially corresponds to the moisture content provided by filler (C).

According to one embodiment, the thermally-conductive two-component composition according to the invention comprises:
from 3% to 40% by weight of silylated polymer in composition (A), relative to the total weight of composition (A),
from 0.2% to 15% by weight of rheological agent (r1) and/or (r2) in composition (A) and/or in composition (B), preferably in composition (A), preferably (r2), relative to the total weight of said composition (A) or (B),
from 1% to 25% by weight of filler (C) in composition (B), relative to the total weight of composition (B), filler (C) providing between 0.0025% and 1% by weight of moisture relative to the total weight of composition (B),
from 50% to 90% by weight of thermally-conductive filler(s) in each of the compositions (A) and (B), relative to the total weight of each of the compositions (A) and (B),
from 0.1% to 3% by weight of adhesion promoter in composition (A) and/or in composition (B), preferably in composition (A), relative to the total weight of said composition (A) or (B),
from 0.01% to 1.5% by weight of crosslinking catalyst in composition (B) relative to the total weight of composition (B),
from 1% to 20% by weight of flame retardant in composition (A) and/or in composition (B), preferably in composition (B), relative to the total weight of said composition (A) or (B), and
from 0.1% to 10% by weight of one or more additives chosen from plasticizers, solvents and UV stabilizers, and mixtures thereof, relative to the total weight of the thermally-conductive two-component composition, the volume ratio of composition (A) relative to composition (B) being between 0.25 and 4.

Preferably, the thermally-conductive two-component composition according to the invention consists essentially of the ingredients mentioned above. The term “consists essentially” means that the thermally-conductive two-component composition according to the invention comprises less than 5% by weight of ingredients other than the abovementioned ingredients, relative to the total weight of said composition, preferably less than 2% by weight, even more preferentially less than 1% by weight.

The ingredients of this embodiment and the particular contents thereof are as described above, including the embodiments.

According to one embodiment, the thermally-conductive two-component composition according to the invention comprises:
from 3% to 40% by weight of silylated polymer in composition (A), relative to the total weight of composition (A),
from 0.2% to 15% by weight of rheological agent (r1) and/or (r2) in composition (A), preferably (r2), relative to the total weight of composition (A),
from 1% to 25% by weight of filler (C) in composition (B), relative to the total weight of composition (B), filler (C) providing between 0.0025% and 1% by weight of moisture relative to the total weight of composition (B),
from 50% to 90% by weight of thermally-conductive filler(s) in each of the compositions (A) and (B), relative to the total weight of each of the compositions (A) and (B),
from 0.1% to 3% by weight of adhesion promoter in composition (A) and/or in composition (B), preferably in composition (A), relative to the total weight of said composition (A) or (B),
from 0.01% to 1.5% by weight of crosslinking catalyst in composition (B) relative to the total weight of composition (B),
from 1% to 20% by weight of flame retardant in composition (A) and/or in composition (B), preferably in composition (B), relative to the total weight of said composition (A) or (B), and
from 0.1% to 10% by weight of one or more additives chosen from plasticizers, solvents and UV stabilizers, and mixtures thereof, relative to the total weight of the thermally-conductive two-component composition, the volume ratio of composition (A) relative to composition (B) being between 0.25 and 4.

Preferably, the thermally-conductive two-component composition according to the invention consists essentially of the ingredients mentioned above.

The ingredients of this embodiment and the particular contents thereof are as described above, including the embodiments.

According to a particular embodiment, the thermally-conductive two-component composition according to the invention comprises:
from 17% to 22% by weight of silylated polymer in composition (A), relative to the total weight of composition (A), the silylated polymer preferably being a polymer of formula (III′),
from 1% to 5% by weight of rheological agent (r2) in composition (A), relative to the total weight of composition (A), the rheological agent (r2) comprising:
   from 5% to 30% by weight of a bis-urea (a) obtained by reaction of an n-alkylamine (a1) comprising from 1 to 22 carbon atoms with a diisocyanate (a2) of formula (V) in which R⁶ is the divalent radical derived from 4,2′-MDI or from 4,4′-MDI, relative to the total weight of said rheological agent (r2), and
   from 70% to 90% by weight of a plasticizer (b) chosen from diisodecyl phthalate, bis(2-propylheptyl) phthalate and mixtures thereof, relative to the total weight of said rheological agent (r2),
from 6% to 11% by weight of filler (C) providing between 0.015% and 0.1% by weight of moisture in composition (B), the weight percentages being relative to the total weight of composition (B), filler (C) being chosen from carbonate fillers, zeolites and mixtures thereof; in particular, filler (C) is precipitated calcium carbonate coated with fatty acids and/or a synthetic zeolite of the type with a pore diameter of 3 Å,
from 70% to 80% by weight of thermally-conductive filler(s) chosen from aluminosilicates and mixtures thereof in each of the compositions (A) and (B), relative to the total weight of each of the compositions (A) and (B),
from 0.5% to 1.5% by weight of adhesion promoter chosen from aminotrimethoxysilanes in composition (A), relative to the total weight of composition (A),
from 0.1% to 0.5% by weight of crosslinking catalyst in composition (B), relative to the total weight of composition (B), the crosslinking catalyst being a tin-based catalyst,
from 8% to 15% by weight of flame retardant in composition (B), relative to the total weight of composition (B), the flame retardant being chosen from tricresyl phosphate, cresyl diphenyl phosphate, tributyl phosphate, trioctyl phosphate, tris(2-ethylhexyl) phosphate, tris(chloroethyl) phosphate, tris(dichloropropyl) phosphate, tris(dibromopropyl) phosphate and mixtures thereof, and
from 2% to 3% by weight of one or more additives chosen from plasticizers, solvents and UV stabilizers, and mixtures thereof, relative to the total weight of the thermally-conductive two-component composition, the volume ratio of composition (A) relative to composition (B) being between 0.8 and 1.2.

Preferably, the thermally-conductive two-component composition according to the invention consists essentially of the ingredients mentioned above.

The ingredients of this embodiment and the particular contents thereof are as described above, including the embodiments.

Advantageously, the thermally-conductive two-component composition according to the invention has very good reactivity, i.e. crosslinking of the silylated polymer after mixing of compositions (A) and (B) occurs rapidly.

This reactivity may be determined by measuring the “open time” of the thermally-conductive two-component composition according to the invention.

The term “open time” means the time between the start of mixing of compositions (A) and (B) and the start of crosslinking of the thermally-conductive two-component composition, during which time users can apply said thermally-conductive two-component composition to the substrate(s) that they wish to assemble.

Preferably, the open time of the thermally-conductive two-component composition according to the invention is less than 30 minutes, more preferentially less than or equal to 15 minutes.

The open time is preferably determined as described in Example 1 hereinbelow.

Advantageously, the viscosity at 21° C. of the thermally-conductive two-component composition according to the invention is less than or equal to 300 000 cP, preferably between 100 000 cP and 280 000 cP.

Advantageously, the viscosity at 21° C. of the thermally-conductive two-component composition according to the invention is determined immediately after its production at 20 rpm (revolutions per minute) and using a Brookfield RVT viscometer and a size 7 needle.

The creep of the thermally-conductive two-component composition according to the invention is advantageously less than 1 inch at 23° C. The creep may be determined according to the standard ASTM D2202.

### Preparation of the Thermally-Conductive Two-Component Composition According to the Invention

Each of the compositions (A) and (B) of the thermally-conductive two-component composition according to the invention is prepared separately, by simply mixing its ingredients, preferably under vacuum.

The term “under vacuum” refers to a pressure below atmospheric pressure, advantageously between 10 kPa and 90 kPa, preferably between 50 kPa and 85 kPa, more preferentially between 60 kPa and 80 kPa.

Advantageously, the thermally-conductive two-component composition according to the invention is prepared without adding free water, that is to say water other than that inherently present in the ingredients of the composition.

According to a preferred embodiment, composition (A) is prepared according to the following process:
1) the silylated polymer is mixed, in a suitable container, with the optional adhesion promoter and/or flame retardant and with the optional additives such as plasticizer, solvent and UV stabilizer (or antioxidant), preferably at a temperature of between 18° C. and 28° C. and under vacuum, and then
2) the optional thermally-conductive filler(s) are dispersed in the preceding mixture at the same pressure, until a homogeneous mixture is obtained, and then
3) the optional rheological agent is added at the same pressure, and the medium is homogenized.

According to a preferred embodiment, composition (B) is prepared according to the following process:
1) the optional adhesion promoter and/or flame retardant and the optional additives such as plasticizer, solvent and UV stabilizer (or antioxidant), are mixed, preferably at a temperature of between 18° C. and 28° C. and under vacuum, and then
2) the filler (C) and the optional thermally-conductive filler(s) are dispersed in the preceding mixture at the same pressure, until a homogeneous mixture is obtained, and then
3) the optional rheological agent is added at the same pressure, and the medium is homogenized, and then
4) the optional crosslinking catalyst is added at the same pressure, and the medium is homogenized.

Preferably, the temperature during the preparation of composition (B) is less than or equal to 50° C., more preferentially less than or equal to 45° C., and even more preferentially less than or equal to 40° C.

An example of preparing compositions (A) and (B) and the thermally-conductive two-component composition according to the invention is described in Example 3.

Compositions (A) and (B) may be packaged, for example, in a dual cartridge. The distribution of the thermally-conductive two-component composition is advantageously performed using a dual-cartridge gun. A homogeneous mixture of the two components is obtained by attaching, for example, a static mixer to the dual cartridge.

### Other Subjects of the Present Invention

The present invention is also directed toward the use of the thermally-conductive two-component composition according to the invention as an adhesive and/or mastic, preferably as an adhesive.

Furthermore, the present invention is also directed toward the use of the thermally-conductive two-component composition according to the invention as an adhesive in the field of building construction, in the field of manufacturing transportation means, preferably of the motor vehicle, rail and aerospace industries, and in the field of shipbuilding, more particularly for assemblies intended for the manufacture of batteries, notably rechargeable batteries for electric cars or hybrid cars.

The present invention also relates to the use of the thermally-conductive two-component composition according to the invention for improving the service life of a battery, preferably a rechargeable battery.

Moreover, the invention relates to the use of a filler (C) having a moisture content of between 0.05% and 5% by weight, relative to the total weight of the filler (C), for the crosslinking without addition of free water of a two-component composition, the two-component composition comprising a composition (A) comprising a silylated polymer, and a composition (B) comprising said filler (C).

The term “free water” means water added to the two-component composition other than that inherently present in the ingredients of said composition.

The filler (C), composition (A), composition (B) and the silylated polymer are advantageously as defined above, including the embodiments. In particular, the filler (C) has a moisture content preferably between 0.1% and 3% by weight, more preferentially between 0.10% and 2%, relative to the total weight of the filler (C).

Advantageously, the two-component composition is a thermally-conductive two-component composition as described above.

Advantageously, the filler (C) is used for rapid crosslinking of a two-component composition, i.e. the use of the filler (C) allows an open time for said two-component composition of less than 30 minutes, preferentially less than or equal to 15 minutes, to be obtained.

The open time is as defined above.

The present invention is also directed toward an article, notably a battery, comprising the thermally-conductive two-component composition according to the invention.

Preferably, the article according to the invention is a battery, in particular a rechargeable battery, more preferentially for an electric or hybrid car.

Finally, the present invention is directed toward to a process for assembling two substrates by adhesive bonding, involving:
coating, onto at least one of the two substrates to be assembled, of the thermally-conductive two-component composition according to the invention, and then
bringing the two substrates into actual contact.

The substrates concerned are very varied and are, for example, inorganic substrates, such as concrete, metals or alloys (such as aluminum alloys, steel, non-ferrous metals and galvanized metals); or else organic substrates, such as wood, plastics such as PVC, polycarbonate, PMMA, polyethylene, polypropylene, polyesters, epoxy resins; or substrates made of metal and composites coated with paint (for instance in the motor vehicle sector). Preferably, the substrates are metals and/or plastics.

All the embodiments described above may be combined with each other. In particular, the various abovementioned ingredients of the thermally-conductive two-component composition according to the invention, and notably the preferred embodiments, may be combined with each other.

The examples that follow are given purely by way of illustration of the invention and should not be interpreted as limiting the scope thereof.

### EXAMPLES

### Example 1: Ingredients and Measurement Methods

### Ingredients Used

The following ingredients were used:
MS Polymer™ SAX 520 sold by Kaneka: trimethoxysilane-terminated poly(propylene oxide) with a number-average molar mass of between 29000 and 31000 g/mol, and a viscosity of 46 Pa·s;
Dynasylan® AMMO sold by Evonik: (3-aminopropyl)trimethoxysilane (CAS No.: 13822-56-5), adhesion promoter;
Calofort® SV14 sold by Specialty Minerals: precipitated calcium carbonate coated with fatty acids, having a mean particle size of 70 nm and a moisture content of 0.2% by weight relative to the total weight of Calofort, filler (C);
Riasorb UV-123 sold by Rianlon: bis(1-octyloxy-2,2,6,6-tetramethyl-4-piperidyl) sebacate (CAS No.: 129757-67-1), hindered amine light stabilizer (HALS);
Tinuvin 770 DF sold by BASF: bis(2,2,6,6-tetramethyl-4-piperidyl) sebacate (CAS No.: 52829-07-9), hindered amine light stabilizer (HALS);
Neostann S-1 sold by Kaneka: product resulting from the reaction of bis(acetyloxy)dioctyltin with tetraethyl orthosilicate (CAS No.: 93925-43-0), crosslinking catalyst;
Hexamoll® DINCH sold by BASF: diisononyl hexahydrophthalate, plasticizer;
n-butylamine, primary aliphatic amine used for the preparation of the rheological agent (r2);
diisodecyl phthalate (DIDP), plasticizer (b) used for the preparation of the rheological agent (r2);
4,4′-diphenylmethane diisocyanate (4,4′-MDI), diisocyanate used for the preparation of the rheological agent (r2);
Disflamoll® DPK sold by Lanxess: cresyl diphenyl phosphate (CDP), flame retardant;
Siliporite® SA 1720 sold by Arkema: type A synthetic zeolite with a pore diameter of 3 Å and a moisture content of 1% by weight relative to the total weight of Siliporite, filler (C);
Silatherme® 1466-126 and Silatherme® 1466-506 sold by The Minerals Engineers: aluminosilicates with d50 particle sizes of 21 μm and 9 μm, respectively, thermally-conductive fillers;
Aerosil® 150 sold by Evonik: fumed silica, rheological agent.

### Measurement Methods

The moisture content of each filler (C) (Calofort® SV14 and Siliporite® SA 1720) is determined using an 870 KF Titrino Plus titrator and an 803 TI stand stirring module, according to the Karl Fisher method, as follows.

The titrant is Hydranal™—Composite 5 (sold by Honeywell), which contains 2-(2-ethoxyethoxy)ethanol and 4.5-5.5 mg of water per mL of titrant. The exact water content of the titrant is checked using a calibration solution comprising 1 mg of water per g of calibration solution (Hydranal™—CRM Water Standard 1.0 sold by Honeywell), by using the titrator's “titer Ipol” program.

The titrator's “KFT Ipol” program is then used to determine the moisture content of the filler (C). The first step in the program is an automatic conditioning step in which traces of water from about 50 mL of dry methanol (Hydranal™—Methanol dry sold by Honeywell) are neutralized with the titrating agent in the stirring module tank. Next, a known mass (about 1 g) of filler (C) is placed in the tank, and the exact mass introduced is then entered into the program, and stirring is continued until the medium is homogeneous (about 1 to 10 min). Finally, titration is performed automatically, and the moisture content of the filler (C) is displayed on the titrator screen.

The tensile strength and elongation at break were measured in accordance with the standard ISO 37 (2005), at a constant speed equal to 500 mm/min.

In particular, the following conditions were applied:

A standard type-2 dumbbell-shaped test specimen, as illustrated in the international standard ISO 37 (2005), is used. The narrow part of the dumbbell used has a length of 20 mm, a width of 4 mm and a thickness of 3 to 4 mm.

To prepare the dumbbell, the test composition is placed in a Teflon mold, and the composition is left to crosslink for 14 days under the standard conditions (23° C. and 50% relative humidity).

The principle of the measurement consists in drawing, in a tensile testing machine, the movable jaw of which is displaced at a constant speed equal to 500 mm/minute, a standard test specimen and in recording:
the elongation at break (expressed in %) is the elongation of the test specimen corresponding to the stretching observed at the time of breaking, and
the tensile strength (in MPa) is the tensile stress at which the test specimen breaks.

The measurement is repeated for five test specimens, and the corresponding mean of the results obtained is calculated.

The open time is determined as corresponding to the skin-forming time. To this end, a bead of mastic (approximately 10 cm long and approximately 1 cm in diameter) is first deposited on a cardboard support. Then, using the tip of a pipette made from low-density polyethylene (LDPE), the surface of the mastic is touched every minute for a maximum of 2 hours in order to determine the exact time at which the skin forms on the surface. This test is performed under controlled conditions of humidity and temperature (23° C. and 50% relative humidity).

The creep is determined at 23° C. in accordance with the standard ASTM D2202 and the self-smoothing is determined at 23° C. by applying a bead of the two-component composition about 1 cm in diameter to a horizontal surface; the composition is self-smoothing if the thickness of the bead reduces to 7 mm or less after 5 minutes.

The viscosity is determined immediately after production of the thermally-conductive two-component composition at 20 rpm (revolutions per minute) and 21° C. using a Brookfield RVT viscometer and a size 7 needle.

The thermal conductivity is measured in accordance with the standard ASTM D5470.

The flammability index is determined in accordance with standard UL 94.

### Example 2: Preparation of the Rheological Agent (r2)

Two solutions are prepared:
a solution A of n-butylamine in DIDP, consisting of 17.17% by weight of n-butylamine and of 82.83% by weight of DIDP, the percentages being relative to the total weight of solution A, and then
a solution B of 4,4′-MDI in DIDP, consisting of 29.46% by weight of 4,4′-MDI in 70.54% by weight of DIDP, the percentages being relative to the total weight of solution B.

The two solutions A and B are heated to 100° C. and then introduced, each under a pressure of 100 bar, into a reactor, in which they are sprayed continuously over each other in a ratio A/B=50.1/49.9 by weight, corresponding to an n-butylamine/MDI mole ratio equal to 2. The reaction is immediate and the temperature of the reactor reaches 140° C. at the end of manufacture.

At the reactor outlet, a stable 23.3% by weight (relative to the total weight of the dispersion) dispersion of a bis-urea in DIDP is obtained, the bis-urea having the formula:

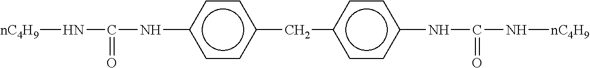

The Brookfield viscosity of the suspension, measured at 23° C., is 15 Pa·s.

### Example 3: Composition 1 According to the Invention Comprising a Composition 1A and a Composition 1B

The various ingredients of each of the compositions 1A and 1B are mixed in the proportions indicated in Tables 1 and 2 below, respectively, in a stirred reactor, in several steps according to the process described below. The reactor is at room temperature (about 23° C.) before the ingredients are added, and the temperature may rise as the ingredients are mixed. The temperature is advantageously controlled so as not to exceed 40° C. during the preparation of composition 1B.

The ingredients of step 1 are mixed under vacuum (between 60 kPa and 80 kPa) and at a stirring speed sufficient to homogenize.

Next, the ingredients of step 2 are slowly added to the reactor used for step 1, again under vacuum and at a stirring speed sufficient to homogenize.

Finally, the ingredients of step 3 are added to the reactor, still under vacuum and at a stirring speed sufficient to homogenize.

TABLE 1

| | | Weight % relative to the total |
|---|---|---|
| Step | Ingredient | weight of composition 1A |
| 1 | MS Polymer ™ SAX 520 | 19.5 |
| | Tinuvin 770 DF | 0.2 |
| | Riasorb UV-123 | 0.5 |
| | Dynasylan ® AMMO | 0.8 |
| 2 | Silatherme ® 1466-506 | 38 |
| | Silatherme ® 1466-126 | 38 |
| 3 | Rheological agent (r2) | 3 |
| | of Example 2 | |

TABLE 2

| | | Weight % relative to the total |
|---|---|---|
| Step | Ingredient | weight of composition 1B |
| 1 | Hexamoll ® DINCH | 4.6 |
| | Disflamoll ® DPK | 11.0 |
| 2 | Silatherme ® 1466-506 | 37.1 |
| | Silatherme ® 1466-126 | 37.1 |
| | Calofort ® SV14 | 9.8 |
| 3 | Neostann S-1 | 0.4 |

The moisture content provided by the filler (C) (Calofort® SV14) is 0.02% by weight relative to the total weight of composition 1B.

Composition 1 according to the invention is then obtained by introducing compositions 1A and 1B into a dual cartridge (protected from air and moisture), then mixing them using a dynamic mixer attached to the end of the dual cartridge, at room temperature (23° C.) in a volume ratio equal to 1.0.

### Example 4: Composition 2 According to the Invention Comprising a Composition 2A and a Composition 2B

The various ingredients of each of the compositions 2A and 2B are mixed in the proportions indicated in Tables 3 and 4 below, respectively, in a stirred reactor, in several steps according to the process described in Example 3.

TABLE 3

| | | Weight % relative to the total |
|---|---|---|
| Step | Ingredient | weight of composition 2A |
| 1 | MS Polymer ™ SAX 520 | 19.2 |
| | Dynasylan ® AMMO | 0.8 |
| 2 | Silatherme ® 1466-506 | 38.5 |
| | Silatherme ® 1466-126 | 38.5 |
| 3 | Rheological agent (r2) of | 3.0 |
| | Example 2 | |

TABLE 4

| | | Weight % relative to the total |
|---|---|---|
| Step | Ingredient | weight of composition 2B |
| 1 | Hexamoll ® Dinch | 4.7 |
| | Disflamoll ® DPK | 11.5 |
| 2 | Silatherme ® 1466-506 | 37.9 |
| | Silatherme ® 1466-126 | 37.9 |
| | Siliporite ® SA 1720 | 7.8 |
| 3 | Neostann S-1 | 0.2 |

The moisture content provided by the filler (C) (Siliporite® SA 1720) is 0.08% by weight relative to the total weight of composition 2B.

Composition 2 according to the invention is then obtained by introducing compositions 2A and 2B into a dual cartridge (protected from air and moisture), then mixing them using a dynamic mixer attached to the end of the dual cartridge, at room temperature (23° C.) in a volume ratio equal to 1.0.

### Example 5: Comparative Compositions 3 and 4

The various ingredients of each of the compositions 3A, 3B, 4A and 4B are mixed in the proportions indicated in Tables 5 and 6 below (the percentages are by weight relative to the total weight of each respective composition), respectively, in a stirred reactor, in several steps according to the process described in Example 3.

TABLE 5

| Step | Ingredient | 3A | 4A |
|---|---|---|---|
| 1 | MS Polymer ™ SAX 520 | 19.8% | 19.2% |
| | Dynasylan ® AMMO | 0.8% | 0.8% |
| 2 | Silatherme ® 1466-506 | 39.7% | 38.5% |
| | Silatherme ® 1466-126 | 39.7% | 38.5% |
| 3 | Aerosil ® 150 | — | 3.0% |

TABLE 6

| Step | Ingredient | 3B | 4B |
|---|---|---|---|
| 1 | Hexamoll ® DINCH | 4.7% | 4.7% |
| | Disflamoll ® DPK | 11.5% | 11.5% |
| 2 | Silatherme ® 1466-506 | 37.9% | 37.9% |
| | Silatherme ® 1466-126 | 37.9% | 37.9% |
| | Siliporite ® SA 1720 | 7.8% | 7.8% |
| 3 | Neostann S-1 | 0.2% | 0.2% |

The moisture content provided by the filler (C) (Siliporite® SA 1720) is about 0.08% by weight relative to the total weight of each composition 3B and 4B.

Comparative composition 3 is then obtained by introducing compositions 3A and 3B into a dual cartridge (protected from air and moisture), then mixing them using a dynamic mixer attached to the end of the dual cartridge, at room temperature (23° C.) in a volume ratio equal to 1.0.

Comparative composition 4 is obtained in a similar manner with compositions 4A and 4B.

### Example 6: Mechanical Properties of Compositions 1-2 According to the Invention and Comparative Compositions 3-4

The mechanical properties of compositions 1-2 according to the invention and of comparative compositions 3-4 (measured in accordance with Example 1) are summarized in Table 7 below.

TABLE 7

| | Composition | | | |
|---|---|---|---|---|
| | 1 | 2 | 3 | 4 |
| | (inven- | (inven- | (compar- | (compar- |
| | tion) | tion) | ative) | ative) |
| Open time (min) | 4 | 10 | 7 | 6 |
| Viscosity at 20 rpm (cP) | <300000 | <300000 | <300000 | >300000 |
| Elongation at break (%) | 80 | 60 | 70 | 60 |
| Tensile strength (MPa) | 1.2 | 1.2 | 1.2 | 1.2 |
| Creep (inch) | <1 | <1 | >1 | <1 |
| Self-smoothing | No | No | Yes | No |
| Thermal conductivity | 1.4 | 1.5 | 1.4 | 1.4 |
| (W/mK) | | | | |
| Flammability index | V-0 | V-0 | V-0 | V-0 |

Compositions 1 and 2 according to the invention have a very short open time (10 min. at most). Thus, the compositions according to the invention crosslink rapidly, whereas the moisture content provided by the filler (C) is very low.

Furthermore, the thermal conductivity of compositions 1 and 2 according to the invention allows them to be used notably in assemblies intended for manufacturing batteries.

Lastly, the viscosity of compositions 1 and 2 allows them to be readily applied with a manual dual cartridge, without the need for a pneumatic gun, and their low creep combined with the fact that they are not self-smoothing enables them to be applied in a non-horizontal position while limiting the risk of sagging.

In contrast, comparative composition 3 not comprising any rheological agent has a creep of greater than 1 inch and is self-smoothing, which means that it will tend to “sag” after application, even in a horizontal position; while comparative composition 4 comprising fumed silica as rheological agent has a viscosity that is too high for it to be readily applied with a manual dual cartridge.

Thus, compositions 1 and 2 according to the invention have the advantage of crosslinking rapidly without the addition of free water, of being sufficiently thermally conductive, and also of being readily applied with a manual dual cartridge while limiting the risk of sagging in a non-horizontal position.

1-13. (canceled)

14. A thermally-conductive two-component composition comprising:
a composition (A) comprising a silylated polymer, and
a composition (B) comprising at least 1% by weight of a filler (C) relative to the total weight of the composition (B), the filler (C) providing at least 0.0025% by weight of moisture relative to the total weight of composition (B),
wherein composition (A) and/or composition (B) also comprise at least one thermally-conductive filler, and
composition (A) and/or composition (B), also comprise:
a rheological agent (r1) chosen from amide waxes and/or
rheological agent (r2) comprising:
from 1% to 40% by weight of a bis-urea (a) obtained by reaction of a primary aliphatic amine with a diisocyanate with a molar mass of less than 500 g/mol, relative to the total weight of the rheological agent (r2), and
from 60% to 99% by weight of a plasticizer (b) chosen from alkyl phthalates, pentaerythritol tetravalerate, alkylsulfonic acid esters of phenol, diisononyl 1,2-cyclohexanedicarboxylate, 3,3′-[methylenebis(oxymethylene)]bis[heptane], dioctyl carbonate and mixtures thereof, relative to the total weight of the rheological agent (r2),
said rheological agent (r2) being in the form of a suspension of solid particles of the bis-urea (a) in a continuous phase of the plasticizer (b).

15. The thermally-conductive two-component composition as claimed in claim 14, in which the silylated polymer comprises at least one alkoxysilane group of formula (I):
in which:

| | |
|---|---|
| —Si(R⁴)ₚ(OR⁵)₃₋ₚ | (I) |

R⁴ represents a linear or branched alkyl radical comprising from 1 to 4 carbon atoms and, when p is equal to 2, the radicals R⁴ are identical or different,
R⁵ represents a linear or branched alkyl radical comprising from 1 to 4 carbon atoms, and, when p is equal to 0 or 1, the radicals R⁵ are identical or different, two groups OR⁵ possibly being engaged in the same ring, and
p is an integer equal to 0, 1 or 2.

16. The thermally-conductive two-component composition as claimed in claim 14, in which the silylated polymer is of formula (II), (III) or (IV): 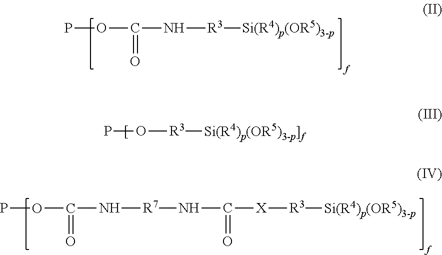
in which:
R⁴, R⁵ and p have the same meaning as in formula (I) described above,
P represents a saturated or unsaturated polymer radical, bearing a linear or branched open chain, or comprising one or more optionally aromatic rings, optionally comprising one or more heteroatoms, such as oxygen, nitrogen, sulfur and/or silicon,
R¹ represents a saturated or unsaturated divalent hydrocarbon-based radical comprising from 5 to 15 carbon atoms, with a linear or branched open chain, or comprising one or more optionally aromatic rings,
R³ represents a linear or branched divalent alkylene radical comprising from 1 to 6 carbon atoms,
X represents a divalent radical chosen from —NH—, —NR⁷— or —S—,
R⁷ represents a linear or branched alkyl radical comprising from 1 to 20 carbon atoms and which may also comprise one or more heteroatoms,
f is an integer ranging from 1 to 6.

17. The thermally-conductive two-component composition as claimed in claim 16, in which the silylated polymer is of formula (II′), (II″), (III′) or (IV′): 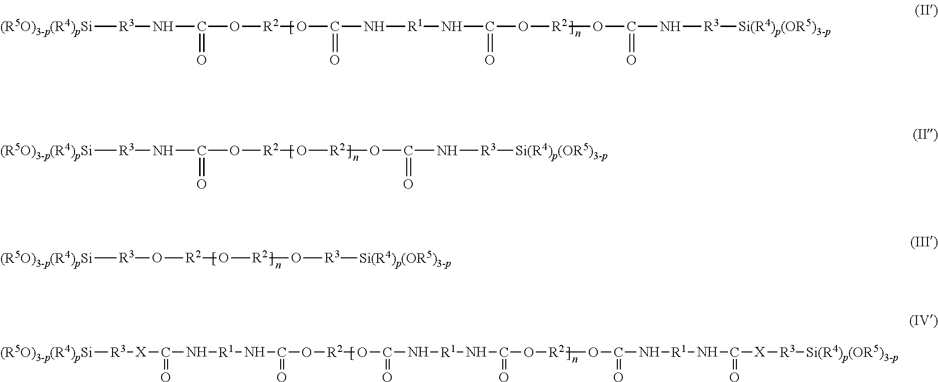
in which:
R¹, R³, R⁴, R⁵, X, R⁷ and p have the same meaning as in formulae (II), (III) and (IV),
R² represents a saturated or unsaturated, linear or branched divalent hydrocarbon-based radical optionally comprising one or more heteroatoms, such as oxygen, nitrogen, sulfur, silicon,
n is an integer, wherein n is such that the number-average molecular mass of the silylated polymer is between 500 g/mol and 70000 g/mol.

18. The thermally-conductive two-component composition as claimed in claim 14, in which the rheological agent (r2) is such that the bis-urea (a) is obtained by reacting an n-alkylamine (a1) comprising from 1 to 22 carbon atoms with a diisocyanate (a2) of formula (V): 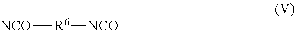
in which R⁶ is chosen from one of the following divalent radicals, of which the formulae below reveal the two free valencies:
i) the divalent radical derived from isophorone: 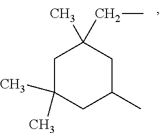
ii) the divalent radical 4,4′-methylenebis(cyclohexyl): 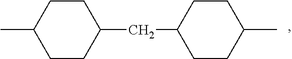
iii) the divalent radical derived from toluene 2,4-diisocyanate (or 2,4-TDI) or from toluene 2,6-diisocyanate (or 2,6-TDI) of respective formulae: 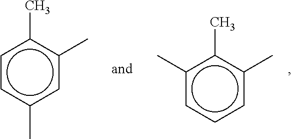
iv) the divalent radical derived from diphenylmethylene 4,2′-diisocyanate (or 4,2′-MDI) or from diphenylmethylene 4,4′-diisocyanate (or 4,4′-MDI), of respective formulae: 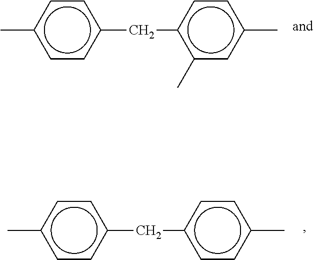
v) the hexamethylene radical: —(CH₂)₆—,
vi) the m-xylylene radical: 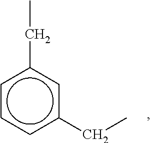
and
vii) the hexahydro-m-xylylene radical:

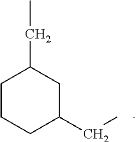

19. The thermally-conductive two-component composition as claimed in claim 14, in which the filler (C) is chosen from clays, talc, kaolins, gypsum, carbonate fillers, zeolites, expandable graphite and mixtures thereof.

20. The thermally-conductive two-component composition as claimed in claim 14, in which the filler (C) is precipitated calcium carbonate coated with fatty acids and/or a type A synthetic zeolite with a pore diameter of 3 Å.

21. The thermally-conductive two-component composition as claimed in claim 14, in which the at least one thermally-conductive filler is chosen from aluminosilicates, alumina, aluminum hydroxide, aluminum nitride, boron nitride, magnesium oxide and mixtures thereof.

22. The thermally-conductive two-component composition as claimed in claim 14, in which each of the compositions (A) and (B) comprises at least one thermally-conductive filler.

23. The thermally-conductive two-component composition as claimed in claim 14, in which composition (A) and/or composition (B) also comprises a flame retardant.

24. The thermally-conductive two-component composition as claimed in claim 14, in which the volume ratio of composition (A) to composition (B) is between 0.25 and 4.

25. A battery comprising the thermally-conductive two-component composition as claimed in claim 14.

26. A method of crosslinking, without addition of free water, a two-component composition, the method comprising providing a two-component composition comprising a composition (A) comprising a silylated polymer, and a composition (B) comprising a filler (C), wherein the filler (C) has a moisture content of between 0.05% and 5% by weight, relative to the total weight of the filler (C).
